(19) United States
(12) Patent Application Publication
(10) Pub. No.: US 2026/0170130 A1
(43) Pub. Date: Jun. 18, 2026

(54) SEMI-SUPERVISED PERFORMANCE INFERENCE MODEL FOR ELIMINATING MALICIOUS DATA PACKETS

(71) Applicant: Fair Isaac Corporation, Minneapolis, MN (US)

(72) Inventors: Scott ZOLDI, San Diego, CA (US); Chenyang LIAN, Richmond, CA (US); V Indukala P, Atlanta, GA (US)

(73) Assignee: FICO, (omitted)

(21) Appl. No.: 18/978,963

(22) Filed: Dec. 12, 2024

(51) Int. Cl. G06F 21/56; G06N 5/022

(52) U.S. Cl. CPC G06F 21/56; G06N 5/022; G06F 2221/034

(57) ABSTRACT

A semi-supervised performance inference system. The system may include a plurality of neurons organized in an array, wherein a neuron comprises a register, a microprocessor, and at least one input. The system may include a plurality of synaptic circuits, a synaptic circuit including a memory for storing a synaptic weight, wherein a neuron is connected to at least one other neuron via one of the plurality of synaptic circuits, where performance of an unknown object in a population of objects is inferenced by constructing a consortium dataset from training data in a plurality of data sources.

### TECHNICAL FIELD

The disclosed subject matter relates to improvements in computer-implemented prediction technologies and more specifically to the implementation and training of machine learning models for performance inference to, among other things, eliminate malicious data packet transmission in a communications network.

### BACKGROUND

Predictive models and technologies are available that can detect malicious data packets in network traffic. A difficulty in detecting a malicious data packet is that a predictive model needs to define a threshold that distinguishes a malicious data packet from an ordinary data packet. Classifying a data packet as malicious or anomalous may be difficult because small variations can trigger an identification of an anomaly in a sensitive application, while relatively larger deviations may be considered normal in less sensitive applications. Further, bad actors may attempt to make malicious data packets appear as ordinary data packets. Solutions are needed that can quickly and accurately identify and eliminate or quarantine malicious data packets in network traffic.

Certain predictive technologies (e.g., machine learning models) can be trained to classify the characteristics (e.g., performance, status, reliability, etc.) of a target population (e.g., data packets, items, objects, entities, applicants, applications, etc.) based on past performances of other populations. A model trained based on known performances (i.e., knowns) can be further trained to predict unknown performances (i.e., unknowns), for example, based on the alignment of the functional connection between a performance score and the expected level of performance (i.e., the score-to-odds relationship) between the knowns and the unknowns.

In the conventional predictive technologies, it is assumed that the score-to-odds relationship between the known and unknown performances is aligned based on the iterations that achieve a predetermined objective. Disadvantageously, the conventional technologies and models do not perform well due to the lack of consideration for the intrinsic differences across distinct populations. More efficient and accurate models are needed that can deliver improved inference results and prediction. It is also desirable that the models are explainable and not opaque.

### SUMMARY

For purposes of summarizing, certain aspects, advantages, and novel features have been described herein. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested herein.

As provided in further detail below, the disclosed subject matter, including any operations or functions claimed, recited, or disclosed, may have utility and technical application beyond that which has been specifically discussed in this application. For instance, certain example applications disclosed are directed to a technology for identifying and eliminating malicious data packets in a communications network. Other applications are directed to identifying credit applicants from an applicant pool for the purpose of approving or denying credit.

Yet, other applications are directed to improving a computing system or predictive model to more efficiently classify items, objects, data packets, applications, applicants, persons, or some types of data that can be classified, where certain populations are known (e.g., have a known performance based on reliable historic data) and other populations are unknown (e.g., have no known performance due to a lack of reliable historic data). In certain implementations, the performance of the known population and data associated with that population is utilized to infer, in a predictive and more accurate manner, the performance of the unknown population or a subset of the unknown population.

As such, without limitation, computer-implemented systems, methods, and products for improved performance inference are provided. In one embodiment, a consortium training dataset is composed to include data from multiple sources to help reduce any bias in training data as consistent with one or more known criteria (e.g., policies, underwriting, and other requirements). In one embodiment, unsupervised learning is applied (e.g., without using any known performance tag information) to the entire training dataset to create a global set of distinctive clusters.

Supervised learning may be utilized to train one or more inference models for distinctive clusters based on known population performances. As provided in further detail below, a trained model may be tagged and used to infer the performance for certain population subsets (e.g., the rejected or the undetermined). A set of evaluation reports may be designed, for both unsupervised and supervised learning, to ensure the results satisfy certain criteria (e.g., the results are to be palatable and comport with logical intuitions and expectations). The resultant inference model has better performance and provides a more transparent and explainable inferencing process.

In accordance with some implementations, a prediction system configured for inferencing performance of a subset of incoming data packets in a population of processed data packets is provided. The prediction system includes at least one programmable processor to perform computing operations. These operations may include constructing a consortium dataset from training data available from a plurality of data sources, wherein the consortium dataset has a first level of data bias and the training data has a second level of data bias different than the first level of data bias.

A first predictive model, including an unsupervised learning model, may be utilized to create a plurality of homogeneous clusters of data associated with a first population of data packets and a second population data packets. In one embodiment, performance of the first population is known and performance of the second population is unknown. Performance or character of a population may indicate the possibility of presence of a malicious data packet corresponding to said population. In one example embodiment, one or more metrics for the plurality of homogeneous clusters are generated to evaluate corresponding properties of at least one or more clusters from among the plurality of homogeneous clusters.

A second predictive model, including a supervised learning model, may be utilized to identify or use data associated with the first population in the at least one or more clusters to infer the performance of the second population. In accordance with one aspect, a set of evaluation reports are generated for the at least one or more clusters, wherein the performance of the second population is validated based on identifiable patterns between the performance of the first population and the performance of the second population.

Accordingly, a malicious data packet may be detected in network traffic based on an evaluation of performance of the malicious data packet against at least one of the performance of the first population and the performance of the second population. The network traffic may include a plurality of data packets. A detected malicious data packet may be quarantined or eliminated from transmission over the network.

The set of evaluation reports, in one or more embodiments, may be generated to confirm that the inferred performances of the second population meet one or more known criteria. According to one or more aspects, the second predictive computer-implemented model is trained based on performances of the first population and the inferred performances of the second population. The first level of data bias may be less than the second level of data bias, in one embodiment. At least one of the plurality of data sources may be associated with a scrutinizing entity, including an entity responsible for approving or denying one or more data packets, for example.

In one or more implementation, the first population includes a first set of processed data with packets with known past performances. And, the second population includes a second set of processed data packets with unknown past performances. The unsupervised predictive computer-implemented model may be trained without use of performance tags. In certain featured implementations, the second population includes rejected or undetermined populations, where the rejected populations include denied processed data packets. The undetermined populations may include processed data packets that are neither denied nor accepted.

The unsupervised learning model may generate the plurality of homogeneous clusters of data by grouping one or more unlabeled datasets into a predefined number of clusters (K). The clusters may be associated with corresponding centroids computed in an iterative process until optimal cluster centroids are determined for the respective clusters. Random data points may be initialized as cluster centroids, a first data point assigned to a closest centroid for a first cluster.

In one example embodiment, new centroids are calculated for the K clusters and the data points are assigned to new centroids forming a new set of clusters as repeated until optimal clusters are formed to minimize within-cluster sum of squares (WCSS) calculated by sum of squared Euclidean distance between a data point and the respective cluster centroid assigned thereto, given by

$${\sum }_{i = 1}^{k} {\sum }_{j = 1}^{{n}_{i}} {‖ {x}_{j} - {c}_{i} ‖}^{2} ,$$

where k is number of clusters, nᵢ is number of data points in cluster i, cᵢ is a centroid of cluster i, and xⱼ is a data point, and where ∥xⱼ−cᵢ∥ represents a distance between a data point and a corresponding centroid.

In one or more embodiments, an application specific integrated circuit (ASIC) for implementing one or more artificial neural networks (ANNs) is provided. The ASIC may include a plurality of neurons organized in an array, wherein a neuron comprises a register, a microprocessor, and at least one input; and a plurality of synaptic circuits, a synaptic circuit including a memory for storing a synaptic weight, wherein a neuron is connected to at least one other neuron via one of the plurality of synaptic circuits, where performance of an unknown object in a population of objects is inferenced by constructing a consortium dataset from training data in a plurality of data sources. The consortium dataset may have a first level of data bias and training data in at least one of the plurality of data sources has a second level of data bias.

A first ANN, including an unsupervised learning model, may be utilized to create a plurality of homogeneous clusters of data associated with known populations of objects and unknown populations of objects. One or more metrics may be generated for the plurality of homogeneous clusters to evaluate corresponding properties of at least one or more clusters from among the plurality of homogeneous clusters. A second ANN, including a supervised learning model, that uses data associated with the known populations of objects in the at least one or more clusters may be utilized to infer performance of the unknown populations of objects. In one embodiment, a set of evaluation reports may be generated for the at least one or more clusters, wherein the performance of the unknown populations is validated based on identifiable patterns between performances of the known population and performances of the unknown populations.

In accordance with some example embodiments, performance of an unknown object in a population of objects is inferenced by constructing a consortium dataset from training data in a plurality of data sources, wherein the consortium dataset has a first level of data bias and training data in at least one of the plurality of data sources has a second level of data bias. The unknown object may include at least one data packet capable of being transmitted over a communications network, the data packet comprising a header portion and a payload portion. The performance of the unknown object, in one aspect, indicates whether the at least one data packet is a malicious data packet. The at least one data packet is quarantined or eliminated from being transmitted over the communications network, in response to determining that the performance of the unknown object indicates the at least one data packet is a malicious data packet.

Implementations of the current subject matter may include, without limitation, systems and methods consistent with the above methodology and processes, including one or more features and articles that comprise a tangibly embodied machine or computer-readable medium operable to cause one or more machines (e.g., computers, processors, etc.) to result in operations disclosed herein, by way of, for example, logic code or one or more computing programs that cause one or more processors to perform one or more of the disclosed operations or functionalities. The machines may exchange data, commands or other instructions via one or more connections, including but not limited to a connection over a network.

The details of one or more variations of the subject matter described herein are set forth in the accompanying drawings and the description below. Other features and advantages of the subject matter described herein will be apparent from the description and drawings, and from the claims. The disclosed subject matter is not, however, limited to any particular embodiment disclosed.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations as provided below.

FIG. 1A is an exemplary network environment in which data packets are transmitted over a communications network, in accordance with one or more aspects disclosed herein.

FIG. 1B illustrates an example flow diagram of a method of developing an improved predictive model for inferencing performance of an unknown population, in accordance with one embodiment.

FIG. 2 is an example flow diagram of a method for inferring performance of an unknown population using a semi-supervised model that utilizes both unsupervised learning and supervised learning, in accordance with one or more implementations.

FIG. 3 illustrates data plots resulting from the application of K-means on an example dataset with two features grouped into five clusters, in accordance with one embodiment.

FIG. 4 illustrates a three dimensional example data plot of cluster distributions across multiple principal components, in accordance with one embodiment.

FIG. 5 illustrates an example decision tree with a depth of 3 levels for a binary tag, in accordance with one embodiment.

FIG. 6 illustrates an example multi-layer neural network, in accordance with one implementation.

FIG. 7A is a diagram of a Fitted Ln (Odds) to consumer bureau score relationship for a rejected population based on inferred performance tags, in accordance with one or more embodiments.

FIG. 7B is a diagram of a Fitted Ln (Odds) to consumer bureau score relationship for an undetermined population based on inferred performance tags.

FIG. 8 is an example flow diagram of a process for inferring performance of an unknown population using a decision tree, in accordance with one embodiment.

FIG. 9A is a diagram of a comparison of Ln (Odds) to bureau score relationship of the disclosed inference model versus traditional models for cluster 1, where at the lower score band of [475,600), 15% lower odds are inferred, and at the higher score band of [750,850], 5% higher odds are inferred.

FIG. 9B is a diagram of a comparison of Ln (Odds) to bureau score relationship of the disclosed inference model versus traditional models for cluster 3, where at the lower score band of [300,500), 43% lower odds are inferred, and at the higher score band of [750,850], 2% higher odds are inferred.

FIG. 9C is a diagram of a comparison of Ln (Odds) to bureau score relationship of the disclosed inference model versus traditional models for cluster 5, where at the lower score band of [450,600), 31% lower odds are inferred, and at the higher score band of [725,850], 5% higher odds are inferred.

FIG. 10A illustrates a block diagram of a computing system in accordance with one or more embodiments.

FIG. 10B illustrates example training and operating environments for a machine learning model, in accordance with one or more embodiments.

The figures may not be to scale in absolute or comparative terms and are intended to be exemplary. The relative placement of features and elements may have been modified for the purpose of illustrative clarity. Where practical, the same or similar reference numbers denote the same or similar or equivalent structures, features, aspects, or elements, in accordance with one or more embodiments.

### DETAILED DESCRIPTION OF EXAMPLE IMPLEMENTATIONS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with specific elements or features should not be construed to qualify the novelty or importance of one feature over the others.

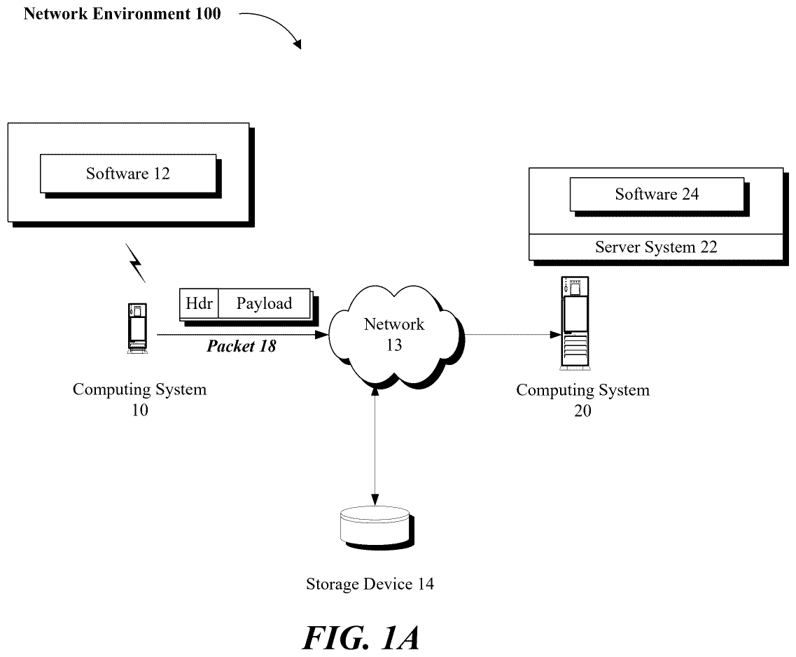

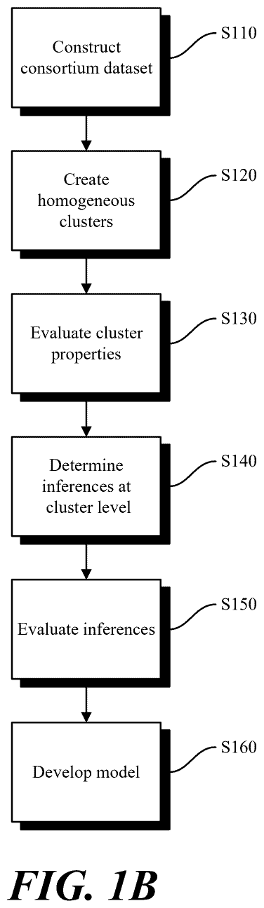

Referring to FIG. 1A, an example network environment 100 is illustrated in which a computing system 10 may be used by a user to interact with software 12 being executed on computing system 10. The computing system 10 may be a general purpose computer, a handheld mobile device (e.g., a smart phone), a tablet (e.g., an Apple iPad®), or other communication capable computing device. Software 12 may be a web browser, a dedicated app or other type of software application running either fully or partially on computing system 10.

Computing system 10 may communicate over a network 13 to transmit data encapsulated in a plurality of data packets 18 to different end points in the network, such as computing system 20 or storage device 14. Depending on implementation, a data packet 18 is structured to include bits of data that are compartmentalized into different portions (not shown) of the data packet 18. These different compartments or portions of the data packet 18 are designated to carry specific information and may be referred to as header and payload, for example. The payload typically includes digitized content intended for consumption by the recipient (e.g., a text message, an email, music, etc.). The header may include, without limitation, information such as the sender's and recipient's addresses, the communication protocol used (e.g., TCP), and sequence numbers to ensure data security and proper reassembly on the receiving end.

Malicious actors, such as cyber criminals, can attempt to corrupt or manipulate the content of a data packet 18 in order to compromise the security of data packets 18 and to gain unauthorized access to content being transmitted over network 13 or content stored on storage device 14. A corrupted or malicious data packet may include a secret encryption key in the header used to encrypt the data within the packet's payload. This allows attackers to send malicious content in network traffic by encrypting the content with a key only known to the attacker. As provided in further detail herein, malicious data packets may be identified by way of analyzing traffic patterns to identify suspicious behavior and indications of anomalous activity or packet characteristics. Reputation-based analysis or filtering may be used, for example, to block or drop data packets from known malicious IP addresses or domains.

Computing system 12 and server system 22 may be implemented over a centralized or distributed (e.g., cloud-based) computing environment as dedicated resources or may be configured as virtual machines that define shared processing or storage resources. Execution, implementation or instantiation of software 24, or the related features and components (e.g., software objects), over server system 22 may also define a special purpose machine that provides remotely situated client systems, such as computing system 10 or software 12, with access to a variety of data stored on storage device 14, which may be local to, remote to, or embedded in one or more of computing systems 10 or 20. A server system 22 may be configured on computing system 20 to service one or more requests submitted by computing system 10 or software 12 (e.g., client systems) via network 30. Network 13 may be implemented over a local or wide area network (e.g., the Internet).

In one implementation, a predictive model is utilized to process a population of objects, items, or entities (e.g., malicious data packets, undesirable sound signals, unrecognizable image data, unknown credit applicants, etc.) based on information available from various data sources. Certain objects, items, or entities are accepted and others are rejected according to the prediction technology implemented in the predictive model.

In one example applicable to detection of malicious data packets, a data packet, if accepted, may be allowed transmission over a network where the data packet may be stored onto a secure non-transitory data medium. If a data packet is suspect according to the application of the predictive model, then the suspect data packet may be rejected (e.g., the data packet may be quarantined or discarded or dropped). If neither accepted or rejected, the data packet may be labeled as “undetermined.”

In an example scenario applicable to credit applicants, if rejected, the applicant is denied credit and the applicant's performance may be labeled as “undetermined.” If the applicant is accepted (e.g., by a financial institution as an acceptable credit risk), the applicant can still decide whether to accept a credit offer, or to decline the credit offer. An accepted applicant who declines a credit offer may be referred to as an undetermined (or an uncashed) applicant, in accordance with one or more embodiments.

In the latter example scenario, for those applicants that are accepted and booked, a lender will ultimately have the accounts' performance data after booking for future origination model development or redevelopment. But for the rejected, by lender or customer, or undetermined applicants, the performance is unknown. Nevertheless, said rejected and undetermined populations may be critical compositions of a full through-the-door application population that can be included in the origination model development to avoid data bias and to increase effectiveness of the system.

If only the accepted applications (with known performances) are included, chances are that the model will be trained with a bias towards the accepted populations with attractive loan offers. Such a model will not work well for rejected, by lender or customer, or undetermined populations primarily due to the corresponding data having been excluded from the model's training data. Therefore, a learning model would perform better if implemented to infer the performance of the rejected and undetermined items, objects, or entities and combine them with their accepted counterparts with known performances. This would result in a final learning model (i.e., an inference model) that captures the nature of the entire through-the-door population for accurate prediction and decision-making.

As provided in further detail herein, the inference model may be implemented to take into account the intrinsic differences across different pools (e.g., data packet populations, applicant populations, etc.) using a clustering method through unsupervised learning. Performance inference may be achieved for the unknown sets or populations through segmented supervised learning models built on homogenous unsupervised clusters and the similarity of applications in key attributes, for example.

TABLE 1

| | Inference | Conventional |
|---|---|---|
| | Model | Model |
| Unsupervised Learning and Clustering | Yes | No |
| Parceling | No | Yes |
| Supervised Learning | Yes | Yes |
| Broad Feature Coverage | Yes | No |
| Alignment Assumption | No | Yes |
| Inference at Sub-pop Level | Yes | No |
| Flexibility to choose algorithm | Yes | No |

Table 1 illustrates a comparative analysis between the improved predictive technology disclosed herein (i.e., an inference model) and the conventional predictive technologies. The improved predictive technology is different from conventional technologies in many dimensions such as the utilization of unsupervised learning and clustering versus purely relying on supervised learning. In one example, the improved predictive technology does not depend on parceling or alignment assumptions made across different populations that may be inherently different (e.g., rejected vs. booked). The framework of the disclosed predictive technology also has many advantages over the conventional technologies, such as flexibility to choose predictive and training processes and broader feature coverage, for example.

Referring to FIG. 1B, in certain embodiments, to reduce data bias, a consortium dataset is constructed from multiple data sources (S110). In this manner, the consortium data overcomes data bias in pre-existing datasets. For example, in a malicious data packet detection scenario, in the initial monitoring process, one network may use a score or an attribute as part of the data packet monitoring criteria. Other networks may not use the same score or an attribute in the same way as cutoff values. Therefore, by combining multiple data sources together, the consortium data reduces or removes any pre-existing bias in a particular packet monitoring network and provides a better foundation for packet characterization inference and model development.

As another example, in the application performance scenario, each lender may have a specific performance portfolio. In the origination process, one lender may use a score or an attribute as part of the origination criteria. Other lenders may not use the same score or an attribute in the same way as cutoff values. Therefore, by combining multiple lenders' data together, the consortium data reduces or removes any pre-existing bias in lender portfolio and provides a better foundation for performance inference and model development.

As shown in FIG. 1B, performance inference may be achieved across known and unknown populations without dependence on the score-to-odds alignment assumption utilized in conventional technologies. In one embodiment, an unsupervised learning model (e.g., K-means) is utilized to create homogeneous clusters of all data packets or applications, including known and unknown populations (e.g., without using any performance tags) (S120). Certain metrics are generated for one or more clusters to evaluate the properties of the one or more clusters (S130). A supervised model, in one aspect, is used to develop a model based on the population with known characteristics (e.g., infected data packet vs. uninfected data packets) or performances (e.g., high risk applicants vs. low risk applicants) for a cluster, and inferring characteristics or performances of unknown populations in at cluster level (S140).

In one or more embodiments, a set of inference reports is generated (e.g., both overall and at cluster level), where the characteristics or performance for the unknown populations, including the rejected or undetermined populations, is inferred through the trained cluster-based models based on the evaluation of inferences (S150). The inferences may be evaluated by, for example, identifying patterns between the known and inferred performances. Pattern identification can include applying statistical methods, data compression techniques in latent spaces, neural network classifiers, expert knowledge, or a combination of one or more of said methods to find classifying patterns between the known and inferred populations.

Pattern recognition, in the case of malicious packets, may include identifying similarities in one or more of payload sizes from certain masked risky IP addresses, geo-location from which the packets are routed or originated, protocols utilized to transmit the data packets, error rates of mal-formed data packets and so on. In the example scenario associated with loan originations, pattern recognition may be based on identifying similar requested loan amounts, detecting customers with similar past delinquency patterns over a certain amount of time (e.g., past 12 months), and so on.

In certain embodiments, a set of evaluation reports may be designed to further inference evaluation by validating the results of clustering and model training and to ensure that the model results are in line with logical intuitions and palatable to use. One or more models may then be developed based on one or more of or both known performances and inferred performances (S160). Depending on implementation, the disclosed methods, systems, and products may be utilized to identify, approve, or disapprove certain items (e.g., quarantine, eliminate, or drop malicious and/or high risk data packets) or entities (e.g., reject high risk applicants).

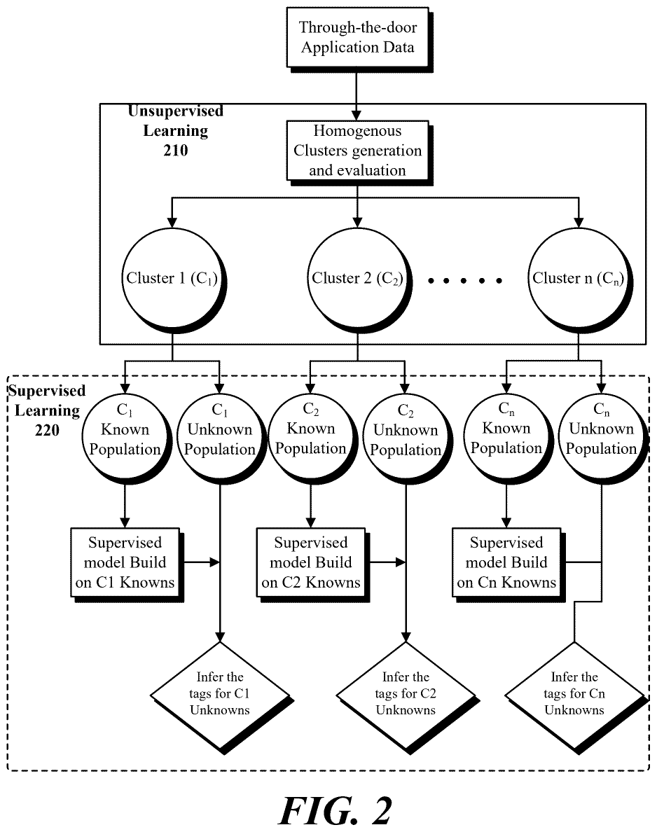

Referring to FIG. 2, a flow diagram of a semi-supervised inference model is provided, where the inference model is trained at two stages using both unsupervised learning 210 and supervised learning 220. In one example applicable to credit applicants, the training data includes data associated with a through-the-door application pool comprising both booked and not-booked applications. The booked applications (knowns) have known tags that identify the applicants as “good” or “bad” risks based on the performances on their respective accounts. The tags are not known for not-booked data (unknowns), in this example.

In another example applicable to malicious data packets, the training data may include data associated with a through-the-door pool of data packets. The through-the-door pool may include both uninfected and infected (i.e., malicious) data packets. The data packets with certain known characteristics (knowns) may have known tags that identify the data packets as “uninfected” or “infected” based on the characteristics associated with their respective profile (e.g., the transmission source of a data packet). The tags may not be known for certain data packets (unknowns), where the transmission source is unknown, for example.

It is noteworthy that in the following, one or more features, operations, or functionalities may be equally applicable to either a predictive technology for processing malicious data packets received and transmitted in a data communications network or alternatively to a predictive technology for processing performances of applications in a credit risk assessment system. To this end, the detailed descriptions disclosed with reference to one example (e.g., malicious data packet monitoring and inference) may be interchangeably applied, without limitation, to another example (e.g., credit risk monitoring and inference) without detracting from the scope of the disclosed subject matter. Other possible applications include processing audio signals for noise removal or transcription, processing clinical data for treatment of patients, image recognition, data format standardization, and other technologies that have a meaningful practical application.

In accordance with one or more embodiments, in the unsupervised learning stage, the data packets or applications are divided into different clusters, without using the tags as input. The data packets or applications within a cluster are homogenous with respect to the various features in the data—a cluster may include both known and unknown populations. In the supervised learning stage, the predictive model is trained and developed within a cluster on the known population using the tags. This model is used to infer the tags of the unknown population in each cluster. Depending on implementation, clusters may be created and evaluated through unsupervised learning, for example, where a set of clusters are created, without limitation, through unsupervised learning models such as K-means, agglomerative clustering, hierarchical clustering, etc.

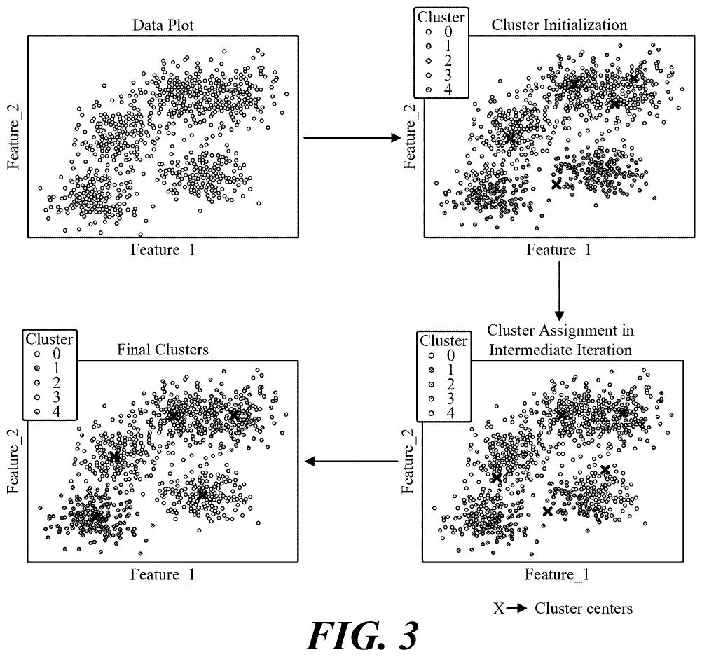

Referring to FIG. 3, the application of K-means on an example dataset with two features grouped into five clusters is illustrated in accordance with an example embodiment. In the example scenario associated with malicious data packets, without limitation, Feature 1 may be related to packet payload size and Feature 2 may be related to packet routing geo-location. In the example scenario associated with credit risk applicants, without limitation, Feature 1 may be related to the primary applicant's credit ratings and Feature 2 may be related to the applicant's number of satisfactory tradelines, for example.

The black ‘X’ in a cluster marks the cluster's centroid, as defined by the average position of the set of points in the cluster (e.g., determined by the sum of all the points' coordinates divided by the number of points). K-Means, as an unsupervised learning model, groups the unlabeled dataset into predefined number of clusters (K), where a cluster is associated with a centroid. For a cluster, the centroid is computed in an iterative process until the optimal cluster centroid is found.

In one example embodiments, a cluster centroid is determined by initializing random data points as the cluster centroid, where the data points are assigned to their closest centroid, forming K clusters. New centroids are calculated for the clusters and the data points are assigned to new centroids, which form a new set of clusters. This process is repeated until optimal clusters are formed. The K-Means procedure aims to minimize the within-cluster sum of squares (WCSS), which is the sum of the squared Euclidean distance between a data point and the cluster centroid the datapoint is assigned to, given by the following formula:

$${\sum }_{i = 1}^{k} {\sum }_{j = 1}^{{n}_{i}} {‖ {x}_{j} - {c}_{i} ‖}^{2} ,$$

where k is the number of clusters, nᵢ is number of data points in cluster i, cᵢ is the centroid of cluster i and xⱼ is the data point. ∥xⱼ−cᵢ∥ represents distance between data point and centroid.

Using an unsupervised algorithm, in one example embodiment, the clustering is run on the full population (booked, rejected, or undetermined) regardless of final origination decision or performance tag availability. By way of non-limiting example, in the credit application scenario, a broad set of features from the application, credit bureaus, or other alternative data sources may be included as candidates to run the clustering algorithm to create segments (clusters) that are vastly different from each other, but homogenous within each cluster across the applications.

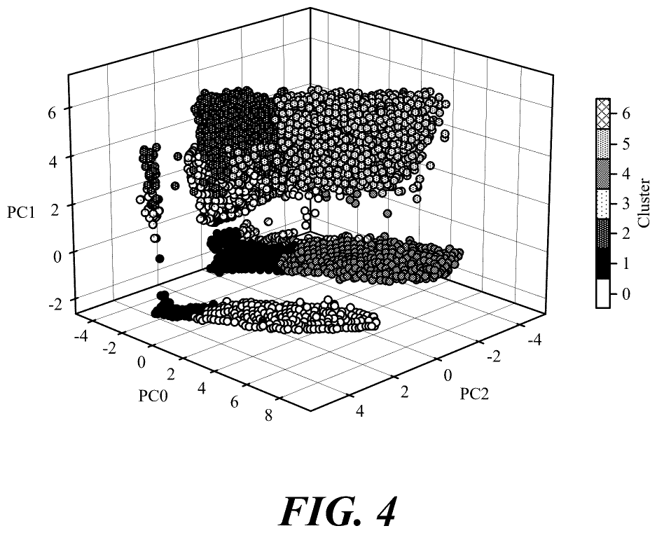

Referring to FIG. 4, principal component analysis may be utilized, in one or more embodiments, as a data compression technique to find vectors (e.g., eigenvectors) that represent an alternate data embedding that is more compact. Eigenvectors refer to a set of vectors associated with a linear system of equations (i.e., a matrix equation) and are also known as characteristic vectors, proper vectors, or latent vectors. A first principal component eigenvector represents a maximal variance of data and a second principal component eigenvector represents a second maximal variance of the same data under the condition that the latter eigenvector is orthogonal to the former.

In certain implementations, two or more principal component vectors may be chosen such that a first principal component (PC0) is computed as the greatest amount of variance in the original features and a second principal component (PC1), orthogonal to the first, explains the greatest amount of variance left after the first principal component. In this manner, the data may be represented as linear combinations of principal components. Principal components are equivalent to a linear transformation of data from the Feature 1×Feature 2 axis (shown in FIG. 3) to a PC0×PC1×PC3 axis (shown in FIG. 4), for example.

Depending on implementation, a principal component eigenvector may be determined based on one or a combination of features associated with an inference model. In the malicious data packet example scenario, PC0 may be determined based on features related to geo-location of routing and sizes of payloads. PC1 may be determined based on features related to protocols utilized to transmit the data packets. And, PC2 may be determined based on features related to error rates of malformed packets, for example. In the credit risk example scenario, PC0 may be determined based on features related to time on book in the bureau and number of satisfactory tradelines. PC1 may be determined based on features related to a co-applicant's bureau rating (e.g., credit score). And, PC2 may be determined based on features related to a primary applicant's bureau rating.

Referring back to FIG. 4, an example cluster distribution across top three principal components (PC0, PC1, PC2) is illustrated. In this example, seven different clusters are generated or selected based on an unsupervised clustering methodology. As shown, each of the clusters has a clear separation from the rest. In this unsupervised learning stage, after the clusters are created, the results are reviewed through a set of evaluation reports so that it can be ensured the clustering results are in line with certain known criteria (e.g., logical intuitions and expectations). In one example, portfolio metrics like bad rate of booked population, acceptance rate, cashed rate, etc. may be generated for one or more clusters as shown in Table 2.

TABLE 2

| | | Bad Rate | Acceptance | |
|---|---|---|---|---|
| Cluster | % Total | (Booked) | Rate | Cashed Rate |
| 6 | 19% | 5.7% | 31.7% | 95.5% |
| 1 | 33% | 2.1% | 72.8% | 93.8% |
| 4 | 12% | 1.2% | 85.7% | 86.7% |
| 3 | 17% | 1.1% | 77.8% | 93.0% |
| 2 | 8% | 1.0% | 78.0% | 91.6% |
| 5 | 6% | 0.6% | 83.4% | 79.0% |
| 0 | 6% | 0.6% | 96.0% | 92.2% |

Table 2 provides examples of cluster level evaluation reports on certain metrics. As shown, the clusters are ordered by the bad rate of booked population. The acceptance rates are broadly in inverse relationship with bad rates, which aligns with logical expectations. The clusters created from unsupervised learning display distinct properties in terms of portfolio metrics like bad rate, rejected rate and undetermined rate (also referred to as cashed rate in this example).

As shown, cluster 6 has a high bad rate, low acceptance rate and high cashed rate, indicating that the cluster contains high risk applications and was heavily rejected during originations process. The cashed rate for these applicants is high as it may be difficult for the applicants to access credit in general. It can also be observed that, broadly, the bad rates and acceptance rates of clusters have an inverse relationship which aligns with the logical expectations. Applications which are more accepted tend to be less risky and hence show low bad rates. Rejecting inferences that align odds across the population are not taken into account to determine the distinct behaviors of clusters.

Referring to Table 3, another way to understand the effectiveness of clustering is through the cluster distributions across certain features (e.g., important features) from various data sources.

TABLE 3

| | Primary applicant | | Co-applicant | |
|---|---|---|---|---|
| | | Median of | | Median of |
| | Applications | maximum | Applications | highest |
| | with missing | delinquency | with missing | revolving |
| | bureau | in consumer | co-applicant | utilization in |
| Cluster | information | bureau | information | consumer bureau |
| 0 | 100.0% | — | 100.0% | — |
| 1 | 8.3% | 8 | 100.0% | — |
| 2 | 1.6% | 8 | 15.6% | 19 |
| 3 | 1.4% | 8 | 94.1% | — |
| 4 | 1.1% | 8 | 99.9% | — |
| 5 | 1.4% | 8 | 11.2% | 23 |
| 6 | 1.1% | 2 | 99.7% | — |

Table 3 illustrates the summary of certain features (e.g., key features) across different clusters 0 through 6, for example. It can be seen that all primary applicants in cluster 0 have no consumer bureau presence, whereas cluster 6 comprises primary applicants with high historical delinquency (e.g., value 8 corresponds to never delinquent and 2 corresponds to charge-off, repossession) consistent with the high bad rate observed in cluster 6. Similarly, cluster 2 has relatively low utilization for co-applicants than cluster 5. Most applications in the rest of the clusters have no co-applicant information. When looked at a combination of different types of characteristics from different data sources, each cluster has a unique set of properties.

As shown, the median maximum delinquency for a primary applicant in bureau-provided data for cluster 6 is 2, which means charge-off or repossession consistent with the high bad rate of booked population observed in cluster 6. With regards to co-applicant information, clusters 0,1,3,4,6 have missing co-applicant information for majority applications. Cluster 2 has relatively low median revolving utilization for co-applicants than cluster 5.

TABLE 4A

| | Cluster 0 | Cluster 1 | Cluster 2 |
|---|---|---|---|
| Consumer Bureau- | No Information | Hit | Hit |
| Primary applicant | | | |
| Consumer Bureau- | No Information | No Information | Low Utilization |
| Co- applicant | | | |
| Alternate Data A | Low Risk | No Information | No Information |
| Alternate Data B | High Time Book | No Information | No Information |
| Bad Rate | Low | High | Moderate |
| Acceptance Rate | Very High | Moderate | Moderate |
| Cashed Rate | Moderate | Moderate | Moderate |

TABLE 4B

| | Cluster 3 | Cluster 4 |
|---|---|---|
| Consumer Bureau- | Hit | Hit |
| Primary applicant | | |
| Consumer Bureau- | No Information | No Information |
| Co- applicant | | |
| Alternate Data A | No Information | High Risk |
| Alternate Data B | No Information | Low Time on Book |
| Bad Rate | Moderate | Moderate |
| Acceptance Rate | Moderate | High |
| Cashed Rate | Moderate | High |

TABLE 4C

| | Cluster 5 | Cluster 6 |
|---|---|---|
| Consumer Bureau- | Hit | High Risk |
| Primary applicant | | |
| Consumer Bureau- | High Utilization | No Information |
| Co- applicant | | |
| Alternate Data A | Moderate Risk | No Information |
| Alternate Data B | Moderate Time on Book | No Information |
| Bad Rate | Low | Very High |
| Acceptance Rate | High | Very Low |
| Cashed Rate | Very Low | High |

Tables 4A, 4B, and 4C include a summary of the cluster properties. The clusters have distinct properties across different data sources and key portfolio metrics. For example, clusters 1 and 3 differ in the bad rate and co-applicant information. Clusters 2 and 3 differ in the co-applicant information. Cluster 0 has missing consumer bureau information for primary applicants. Cluster 6 has high risk applicants. The distributions of clusters may be analyzed across features from alternate data sources to understand the composition of each cluster. All the clusters have distinct properties across data sources and key population metrics. As shown, clusters 2 and 3 have similar attributes other than cluster 2 having co-applicants with low-utilization. Cluster 3 has no co-applicants. Beyond using the clusters for performance inference, the resulting clusters and insights from the unsupervised learning may provide a powerful tool for the lenders to understand better the customer base, application attributes, and potentially leveraging these insights for certain targeted strategies.

In accordance with one or more embodiments, a supervised model may be trained on one or more of the clusters before the inferencing process is initiated. The final inferred datasets for unknown populations may be combined with the known population as final modeling dataset for the origination model development. Depending on the data and specific project requirements, an inference model may be implemented based on supervised learning, with a flexible framework to choose from one or more supervised learning models, such as a decision tree, logistic regression, a scorecard, a neural network, etc.

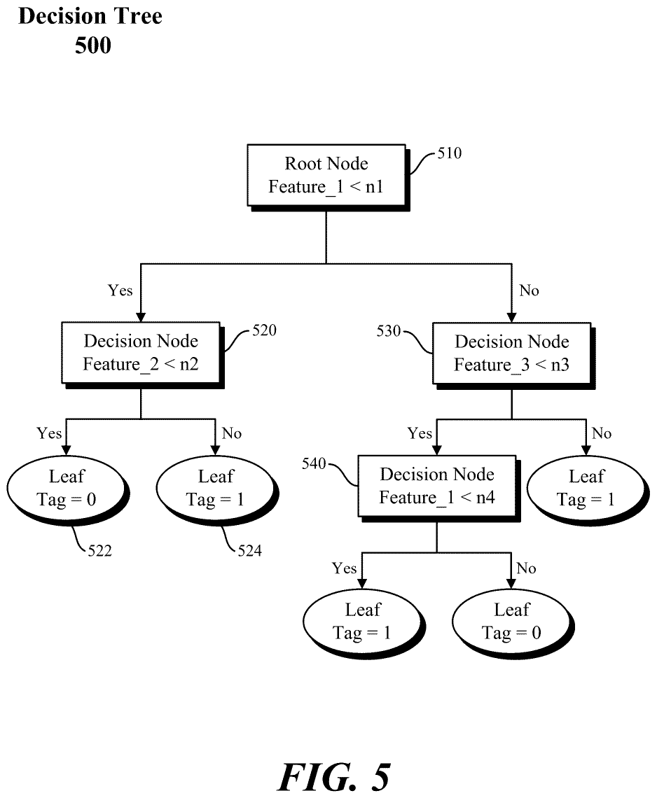

Referring to FIG. 5, an example decision tree 500 implementation is provided. The example decision tree 500 has a depth of 3 levels for a binary tag. As shown, the decision tree 500 is a flowchart-like data structure with a root node 510 and multiple decision nodes 520, 530, and 540. A decision node represents a probability test on an attribute (e.g., whether a coin flip comes up heads or tails), and a yes or no branch represents the outcome of the test. A leaf node (e.g., leaf 522) represents a class label or value (e.g., 0 or 1) which refers to a decision taken after computing one or more attributes.

Decision tree 500, using a supervised machine learning model, may be utilized for classification or regression analysis. As shown, root node 510 is the initial node at the beginning of a decision tree, where the entire population or dataset starts dividing based on various features or conditions. Decision nodes are intermediate decisions or conditions within the tree which result from the splitting of root nodes or other decision nodes. Leaf nodes indicate the final classification or outcome. At each decision node, the model looks for a certain feature (e.g., the most important feature) that splits the data into the most distinct groups of tags by using impurity measures such as Gini impurity, for example, given by:

$$Gini Impurity ( G ) = 1 - {\sum }_{i = 0 , 1} {p}_{i}^{2}$$

where pᵢ is the probability of samples belonging to class i at a given node.

In this example, when the data is split into two branches B1 and B2 at a decision node, the Gini impurity in resultant split is calculated by

$$\frac{{n}_{1} {G}_{1} + {n}_{2} {G}_{2}}{{n}_{1} + {n}_{2}} ,$$

where G₁, G₂ are Gini impurities of B1 and B2 and n₁, n₂ are the number of data points in branches B1 and B2. At a decision node, the attribute split that provides the smallest Gini impurity, for example, is chosen to split the node.

In accordance with one or more embodiments, a neural network (also referred to as an artificial neural network or ANN) may be utilized to implement all or parts of the disclosed inference model. The neural network is capable of performing a wide variety of complex tasks, such as detection of anomalies based on training data. As provided in further detail below, the neural network may include a series of neural layers, comprising one or more neurons (e.g., nodes) arranged in computer-implemented data arrays (e.g., neuron arrays) or other forms of data structures. In one example, a neuron may be implemented in a hardware register or computer memory that can receive at least one input and produce at least one output.

Certain neurons in a neural array may be activated based on an activation function that uses outputs of a previous neural layer (e.g., a hidden layer) and a set of weights (w) as inputs. The weights are values that are adjusted through a learning process aimed to improve or optimize the neural network's prediction accuracy and functionality. A neuron in a neuron array may be connected to another neuron via a synaptic circuit, which allows the connected neurons to interact. A synaptic circuit may include a computer memory for storing one or more weights (i.e., synaptic weights). The neural network may have an input layer, an output layer, and a plurality of fully connected intermediate layers configured to effectively extract features in linear and nonlinear relationships.

In some embodiments, the disclosed inference model is implemented as a neural network utilizing an application-specific integrated circuit (ASIC) customized to provide superior computing capabilities and reduced power consumption. The neural network may be trained using discretized training data to learn patterns that identify or detect potential anomalies or consistencies for the purpose of determining the proper inferences. Training data may include continuous data (i.e., data that is measured and can have any number of possible values) that is used to generate discrete data (i.e., data that can be counted and has a limited number of values). A discretization method may be used to convert continuous data to discrete data used to train the neural network.

Backpropagation and gradient descent or other methodologies may be used to train certain aspects of the neural network. Backpropagation which is a mathematical calculation for supervised learning uses gradient descent such that, given an error function, the gradient of the error function is determined with respect to the neural network's weights that define the relationships between the neural network neurons. The gradient descent process includes initializing values of parameters of interest and applying mathematical calculations to iteratively adjust the weight values towards minimizing a loss function that optimizes the performance of the neural network.

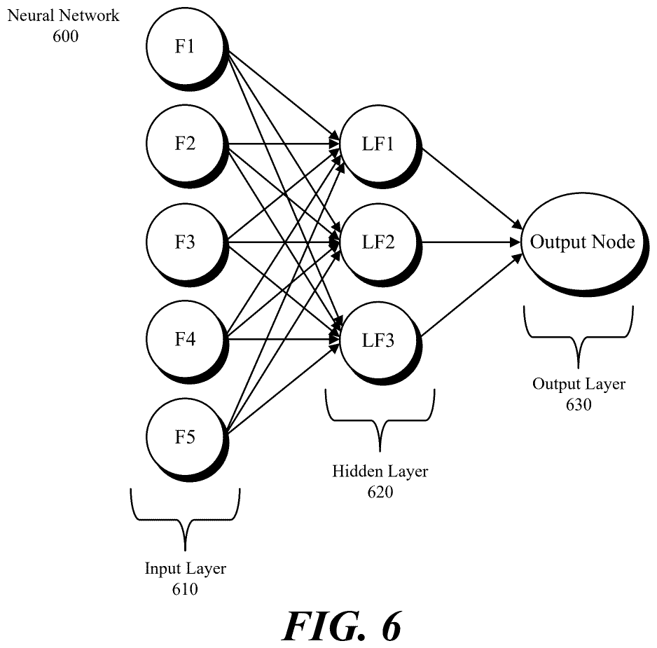

Referring to FIG. 6, an example neural network 600 with an input layer 610 composed of 5 input features (F1 through F5) is provided. As shown, a single hidden layer 620 (e.g., composed of three latent features (LF1, LF2, LF3)) and an output layer 630 combining the latent features into an output node are included. The directional edges connecting the three latent features to the output node represent the free or adjustable parameters (e.g., weights) that a neural network learns during training. Latent features in hidden layers take input from the features in the input layer or latent features in previous hidden layers (e.g., in case of neural networks with multiple hidden layers). The latent features apply non-linear transformations (i.e., activation functions) on the inputs enabling the neural network to capture complex non-linear patterns in the data. Activation function of a latent feature k is given by:

$$Activation Function of {LF}_{k} = f ( {w}_{1}^{k} {x}_{1}^{k} + {w}_{2}^{k} {x}_{2}^{k} + … + {w}_{n}^{k} {x}_{n}^{k} )$$

where

$${x}_{1}^{k} , {x}_{2}^{k} , … {x}_{n}^{k}$$

are inputs to latent feature and

$${w}_{1}^{k} , {w}_{2}^{k} , … {w}_{n}^{k}$$

are weights of the inputs respectively.

In example of FIG. 6, there are 18 weights (i.e., 15 between the input layer 610 and hidden layer 620 plus three between hidden layer 620 and output layer 630) to be learned and optimized. Using a suitable supervised learning approached noted earlier, the model is developed based on the known performance population within a specific cluster (i.e., the populations that are accepted and booked with actual known performance data within that specific cluster). In one or more embodiments, the inference models for one or more clusters (e.g., see FIGS. 3 and 4) are completed through a predetermined supervised learning approach (e.g., a decision tree as shown in FIG. 5) applied to the known performance population within each cluster. Accordingly, the unknown performance for the rejected and undetermined populations in each specific cluster can be inferred through the cluster specific trained models.

Like the reports generated to evaluate the effectiveness of clustering, the final inferenced results may be evaluated on different populations to ensure that the inferencing is achieving predetermined goals and is meeting the intended expectations. A set of inferencing evaluation reports can be generated and reviewed as shown in Table 5.

TABLE 5

| | Bad Rate | | | |
|---|---|---|---|---|
| | (Booked - | Bad Rate | Bad Rate | Bad Rate |
| Cluster | Knowns) | (All Population) | (Rejected) | (Undetermined) |
| 6 | 5.7% | 7.9% | 8.9% | 6.0% |
| 1 | 2.1% | 2.4% | 3.5% | 1.3% |
| 4 | 1.2% | 1.6% | 4.0% | 1.2% |
| 3 | 1.1% | 2.2% | 5.6% | 1.6% |
| 2 | 1.0% | 1.6% | 3.9% | 0.8% |
| 5 | 0.6% | 0.8% | 2.0% | 0.5% |
| 0 | 0.6% | 0.6% | 1.4% | 0.4% |

Table 5 is an example of cluster level inference results on bad rate comparison across the populations of booked, rejected, undetermined, and overall. The clusters are ordered by the bad rate of booked population. As shown, the rejected population has higher bad rates compared to known population across all clusters, and the undetermined population's bad rate is either similar to or less than the known population bad rate which can be thought of as being accepted but abandoning a credit offer due to unattractive credit terms or being highly decerning.

In an example scenario with a practical application to consumer credit ratings, risk levels may be measured by odds, which is the ratio of goods to bads (i.e., good credit risk vs. bad credit risk). That is, higher odds for a population reflect more good accounts (less risky) compared to bad accounts (more risky). In other words, a population associated with relatively low odds may be deemed less risky compared to another population that is associated with relative high odds.

TABLE 6

| | | | | Known Odds/ |
|---|---|---|---|---|
| Odds Comparison | % Good | % Bad | Odds | Inferred Odds |
| Known Population | 98% | 2% | 54.85 | |
| Rejected (Inferred) | 94% | 6% | 15.61 | 54.85:15.61 = 3.51 |
| Undetermined | 99% | 1% | 77.43 | 54.85:77.43 = 0.71 |
| (Inferred) | | | | |
| Total Population | 97% | 3% | 31.98 | 54.85:31.98 = 1.72 |

Table 6 illustrates example odds comparison across the known, rejected, undetermined, and total populations. The rejected population has low inferred odds compared to odds of known population. High risk applications are generally rejected during the application process. The inferred odds of the undetermined is higher than the known population odds because the undetermined are applications that were accepted but the customer did not take up the offer, probably because of less attractive terms. They are expected to have similar or higher odds than known population. As such, Table 6 provides for a direct comparison between the odds of different populations and shows that, at an overall level, the rejected have lower odds than the known population and the undetermined have higher odds than known population.

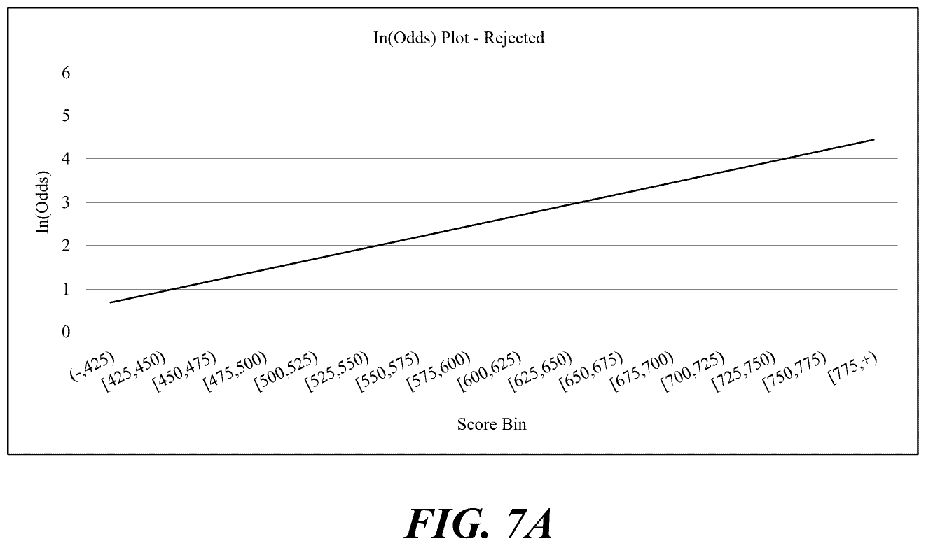

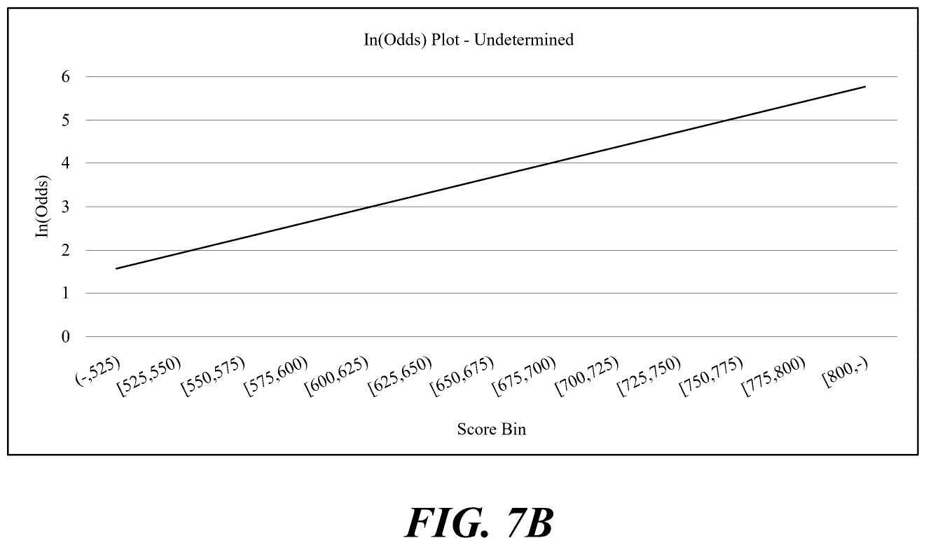

Referring to FIGS. 7A and 7B, in certain implementations, one or multiple consumer bureau credit scores, or any other scores (e.g., previous originations score) may be available. In such cases, it is beneficial to generate the odds-to-score chart. High consumer bureau score corresponds to low-risk applications (higher odds) and low score corresponds to high risk (lower odds). This pattern can be observed, as shown, when the applications are grouped into different bins based on the consumer bureau score. A line is fitted through the log of odds calculated within each bin. For both rejected and undetermined populations the inferred odds have an increasing relationship with the score bins. As shown in FIGS. 7A and 7B, lower odds (higher bads) are inferred in the low score ranges and higher odds (lower bads) are inferred in higher score ranges. The inferred bad rate for rejected and undetermined is rank ordering with the consumer bureau score.

### Study Illustrating Advantages Over Conventional Predictive Technologies

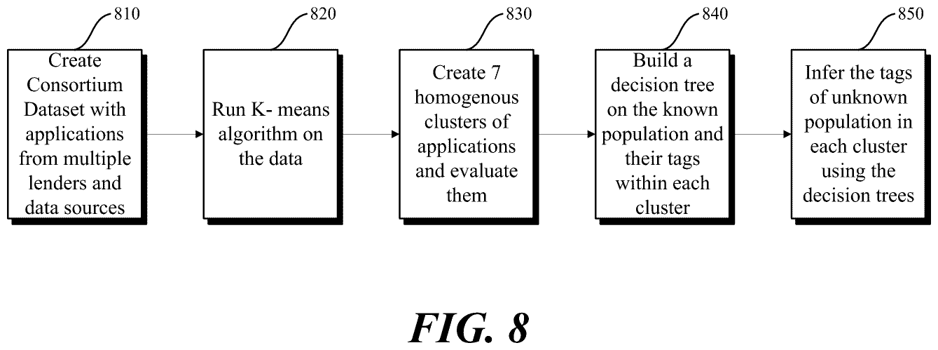

Referring to FIG. 8, to demonstrate the effectiveness of the inference model disclosed herein, a comparative inference study is provided below using the same dataset for both the disclosed inference model and the less efficient conventional models. As shown in FIG. 8, in one embodiment, a consortium dataset is created based on applications received from multiple lenders and data sources (S810). In one example implementation, a K-means model is applied to the dataset for unsupervised cluster generation (S820). In this example, a total of 7 homogenous clusters of applications are generated and evaluated (S830). A decision tree is built for supervised learning in the clusters based on data associated with the known population and the corresponding tags within the clusters (S840). The tags of the unknown population are inferred in the clusters using the decision tree (S850).

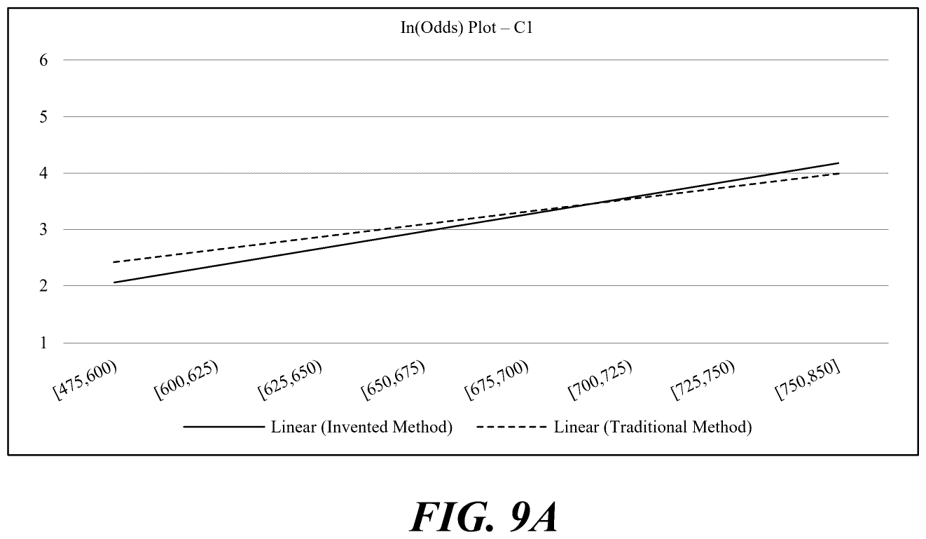

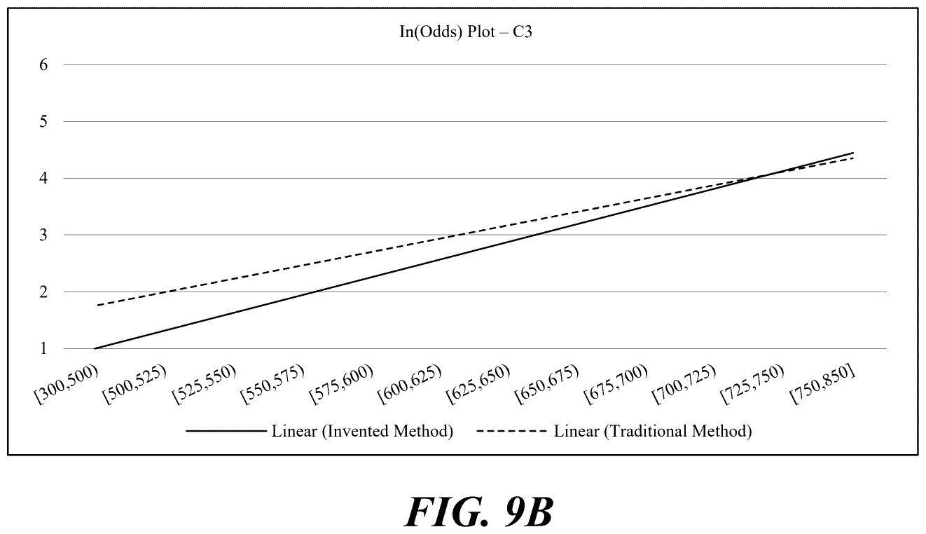

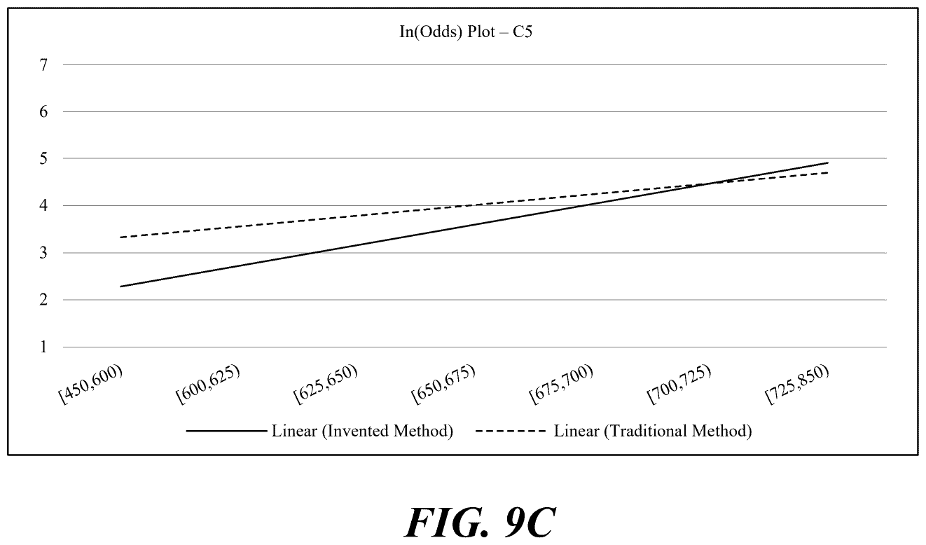

Referring to FIGS. 9A, 9B, and 9C, the inferred population can be compared within each cluster using score-to-In (odds). The performance of the models built using the inference model and the conventional models are compared, as shown in Tables 7 and 8. The results provide insights on the credit applications based on the unsupervised clustering of the entire through-the-door population using a broad set of features across multiple data sources and bureaus information and by not using the biased lender's credit decision and extrapolating performance globally.

Advantages of the disclosed inference model include better risk separation between the inferred goods versus inferred bads within clusters, in terms of bureau score differences, as indicated by the In (odds) to bureau score relationship in FIGS. 9A, 9B, and 9C. For both the disclosed inference model and the conventional model, all goods and bads (AGB) models were built to confirm the performance advantages over the conventional technologies (including both known and inferred tags). At the cluster level, in most of the clusters, the lift over the conventional technology was more pronounced.

TABLE 7

| Segment | Invented Method KS | Traditional Method KS | % lift in KS |
|---|---|---|---|
| 0 | 0.398 | 0.293 | 35.8% |
| 1 | 0.354 | 0.326 | 8.6% |
| 2 | 0.558 | 0.432 | 29.0% |
| 3 | 0.453 | 0.390 | 16.0% |
| 4 | 0.467 | 0.392 | 19.3% |
| 5 | 0.571 | 0.474 | 20.3% |

Referring to Table 7, cluster level performance comparison of AGB model on all population is illustrated. The Kolmogorov-Smirnov test statistic of model built on known and inferred population using disclose inference method is compared with model built on known and inferred population using the conventional model. Cluster 0 has highest lift of 35.8% in KS followed by cluster 2 with 29% and cluster 5 with 20%. These significant differences in KS can result in more accurate outcomes based on customer profiles within each cluster leading to more fairer outcomes for customers. Performance results in Table 7 show that the disclosed inference model outperforms the conventional technologies in terms of prediction accuracy. For example, cluster 0 has the highest lift of 35.8% in KS which would result in more accurate outcomes based on customer profiles within a cluster leading to more fairer outcomes for customers.

Further evaluation on the performance of AGB models on Known population (True Good and Bad) provides that the disclosed inference model outperforms the conventional models in known goods and bads population. At the cluster level, in most of the clusters, the lift over the traditional method is even more significant.

TABLE 8

| Segment | Invented Method KS | Traditional Method KS | Golift in KS |
|---|---|---|---|
| 0 | 0.397 | 0.306 | 30.0% |
| 2 | 0.452 | 0.434 | 4.2% |
| 4 | 0.406 | 0.380 | 6.9% |
| 6 | 0.238 | 0.226 | 5.6% |

Table 8 reflects cluster level performance comparison of AGB model on known population. Cluster 0 has the highest lift of 30% in KS for known population, indicating that the disclosed inference model provides better separation between known goods and known bads leading to more accurate and fairer outcomes.

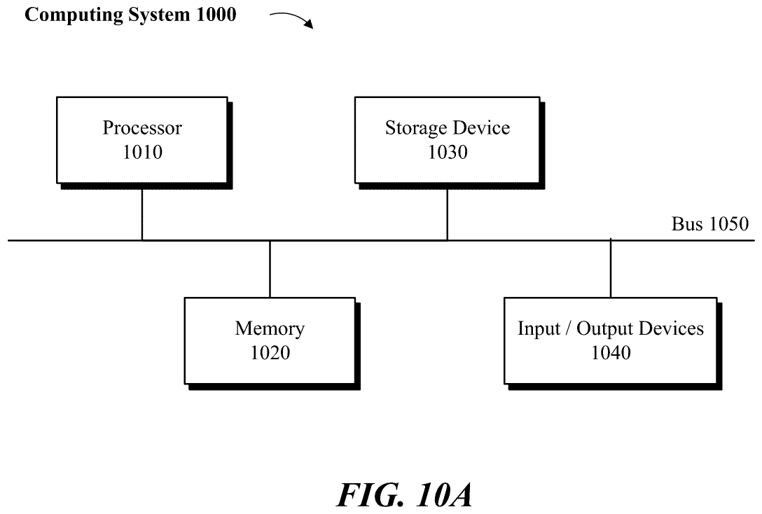

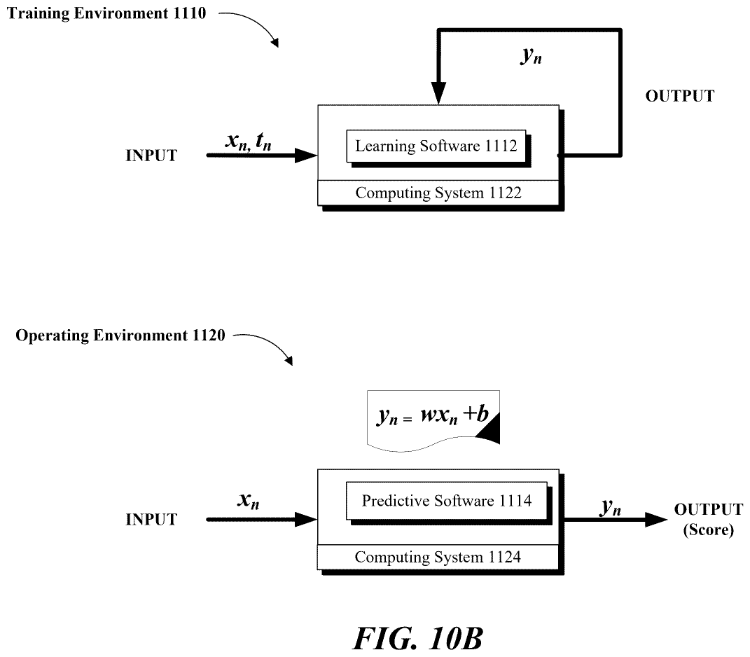

Referring to FIG. 10A, a block diagram illustrating a computing system 1000 consistent with one or more embodiments is provided. The computing system 1000 may be used to implement or support one or more platforms, infrastructures or computing devices or computing components that may be utilized, in example embodiments, to instantiate, implement, execute or embody the methodologies disclosed herein in a computing environment using, for example, one or more processors or controllers, as provided below.

As shown in FIG. 10A, the computing system 1000 can include a processor 1010, a memory 1020, a storage device 1030, and input/output devices 1040. The processor 1010, the memory 1020, the storage device 1030, and the input/output devices 1040 can be interconnected via a system bus 1050. The processor 1010 is capable of processing instructions for execution within the computing system 1000. Such executed instructions can implement one or more components of, for example, a cloud platform. In some implementations of the current subject matter, the processor 1010 can be a single-threaded processor. Alternately, the processor 1010 can be a multi-threaded processor. The processor 1010 is capable of processing instructions stored in the memory 1020 and/or on the storage device 1030 to display graphical information for a user interface provided via the input/output device 1040.

The memory 1020 is a computer readable medium such as volatile or non-volatile that stores information within the computing system 1000. The memory 1020 can store data structures representing configuration object databases, for example. The storage device 1030 is capable of providing persistent storage for the computing system 1000. The storage device 1030 can be a floppy disk device, a hard disk device, an optical disk device, or a tape device, or other suitable persistent storage means. The input/output device 1040 provides input/output operations for the computing system 1000. In some implementations of the current subject matter, the input/output device 1040 includes a keyboard and/or pointing device. In various implementations, the input/output device 1040 includes a display unit for displaying graphical user interfaces.

According to some implementations of the current subject matter, the input/output device 1040 can provide input/output operations for a network device. For example, the input/output device 1040 can include Ethernet ports or other networking ports to communicate with one or more wired and/or wireless networks (e.g., a local area network (LAN), a wide area network (WAN), the Internet).

In some implementations of the current subject matter, the computing system 1000 can be used to execute various interactive computer software applications that can be used for organization, analysis and/or storage of data in various (e.g., tabular) format (e.g., Microsoft Excel®, and/or any other type of software). Alternatively, the computing system 1000 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 1040. The user interface can be generated and presented to a user by the computing system 1000 (e.g., on a computer screen monitor, etc.).

As noted earlier, certain aspects or features of the subject matter disclosed or claimed herein may be realized using machine learning models, which are capable of representing a predictive relationship between a set of input variables and value of one or more output labels or outcomes. Typically, training data that includes input variables and known outputs is provided to a machine learning training system. Based on the input, values are assigned to free parameters in the machine learning model such that the model can be used to predict the output label, or the predicted distribution, given the set of input data.

Machine learning or AI models, also referred to as artificial neural networks, demonstrate flexible predictive power across a substantially large variety of domains. The functional form of an AI model may be designed based on the structure and learning ability of biological brains, which is highly flexible as compared to classical parametric models. This flexibility can unlock a high non-linear predictive ability in a compact and efficient form. The enhanced predictability can advantageously enable high prediction accuracy, a low false positive rate, compared to traditional statistical models.

Most AI models are associated with certain significant downsides, such as a highly complex and multi-layered network of nodes that is used to implement the AI models. Due to the opaque and complex nature of their features, these models are typically referred to as “black boxes”—the human mind, including the mind of the designers of the models, is often not fully capable of appreciating and understanding the complexity of unraveling rationale and weights of connections in the model architecture.

Various explainable AI techniques can be utilized to provide some level of external human understanding, but most of these techniques involve methods that use approximations under assumptions which can be invalid, especially when the designer cannot fully appreciate the functionality of a model. Further, applications of explainable AI may not be suitable or comprehensive to meet current regulatory standards, causing organizations to abandon the use of neural networks. As such, the human designer of these predictive machines cannot currently ensure that certain constraints derived from domain knowledge or secondary analysis are satisfied.

In a predictive model, it may be important to ensure that, for example, the credit risk estimated based on a loan-delinquency increases as the amount of delinquent dollars increases. Or, it may be desirable to prohibit a nonlinear interaction between variables that may be predictive but are disallowed by regulators. The designer or the ultimate user of the model may desire to impose the above constraints (and other requirements) to ensure compliance with regulation and reasonable performance as well as to reduce model risk, if the model is to be used in production where relationships may drift from the data set used for model training.

Referring to FIG. 10B, example training environment 1010 and operating environment 1120 are illustrated. As shown, a computing system 1122 and training data may be used to train learning software 1112. Computing system 1122 may be a general-purpose computer, for example, or any other suitable computing or processing platform. Learning software 1112 may be a machine learning or self-learning software that receives event-related input data. In the training phase, an input event may be known as belonging to a certain category (e.g., fraudulent or non-fraudulent) such that the corresponding input data may be tagged or labeled as such.

It is noteworthy that while certain example embodiments may be implemented in a direct classification (e.g., hard classification) environment, other possible embodiments may be directed to score-based classification in a probabilistic sense (e.g., soft classification) as well as regression. Accordingly, learning software 1112 may process the input data associated with a target event, without paying attention to the labels (i.e., blindly), and may categorize the target event according to an initial set of weights (w) and biases (b) associated with the input data. When the output is generated (i.e., when the event is classified by learning software 1112), the result may be checked against the associated labels to determine how accurately learning software 1112 is classifying the events.

In the initial stages of the learning phase, the categorization may be based on randomly assigned weights and biases, and therefore highly inaccurate. However, learning software 1112 may be trained based on certain incentives or disincentives (e.g., a calculated loss function) to adjust the manner in which the provided input is classified. The adjustment may be implemented by way of adjusting weights and biases associated with the input data. Through multiple iterations and adjustments, the internal state of learning software 1112 may be continually updated to a point where a satisfactory predictive state is reached (i.e., when learning software 1112 starts to more accurately classify the inputted events at or beyond an acceptable threshold).

In the operating environment 1120, predictive software 1114 may be utilized to process event data provided as input. It is noteworthy that, in the operating phase, input data is unlabeled because the classification (e.g., the fraudulent nature) of events being processed is unknown to the model. Software 1114 may generate an output that classifies a target event as, for example, belonging to a first class (e.g., the fraudulent category), based on fitting the corresponding event data into the first class according to the training data received during the training phase. In accordance with example embodiments, predictive software 1114 may be a trained version of learning software 1112 and may be executed over computing system 1124 or another suitable computing system or computing infrastructure to generate one or more outputs, classifications or scores that can be used to make determinations or predictions.

One or more aspects or features of the subject matter disclosed or claimed herein may be realized in digital electronic circuitry, integrated circuitry, specially designed application specific integrated circuits (ASICs), field programmable gate arrays (FPGAs) computer hardware, firmware, software, and/or combinations thereof. These various aspects or features may include implementation in one or more computer programs that may be executable and/or interpretable on a programmable system including at least one programmable processor, which may be special or general purpose, coupled to receive data and instructions from, and to transmit data and instructions to, a storage system, at least one input device, and at least one output device. The programmable system or computing system may include clients and servers. A client and server may be remote from each other and may interact through a communication network. The relationship of client and server arises by virtue of computer programs running on the respective computers and having a client-server relationship to each other.

These computer programs, which may also be referred to as programs, software, software applications, applications, components, or code, may include machine instructions for a programmable controller, processor, microprocessor or other computing or computerized architecture, and may be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium may store such machine instructions non-transitorily, such as for example as would a non-transient solid-state memory or a magnetic hard drive or any equivalent storage medium. The machine-readable medium may alternatively or additionally store such machine instructions in a transient manner, such as for example as would a processor cache or other random access memory associated with one or more physical processor cores.

To provide for interaction with a user, one or more aspects or features of the subject matter described herein may be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices may be used to provide for interaction with a user as well. For example, feedback provided to the user may be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive trackpads, voice recognition hardware and software, optical scanners, optical pointers, digital image capture devices and associated interpretation software, and the like.

### Terminology

When a feature or element is herein referred to as being “on” another feature or element, it may be directly on the other feature or element or intervening features and/or elements may also be present. In contrast, when a feature or element is referred to as being “directly on” another feature or element, there may be no intervening features or elements present. It will also be understood that, when a feature or element is referred to as being “connected”, “attached” or “coupled” to another feature or element, it may be directly connected, attached or coupled to the other feature or element or intervening features or elements may be present. In contrast, when a feature or element is referred to as being “directly connected”, “directly attached” or “directly coupled” to another feature or element, there may be no intervening features or elements present.

Although described or shown with respect to one embodiment, the features and elements so described or shown may apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments and implementations only and is not intended to be limiting. For example, as used herein, the singular forms “a”, “an” and “the” may be intended to include the plural forms as well, unless the context clearly indicates otherwise. It will be further understood that the terms “comprises” and/or “comprising,” when used in this specification, specify the presence of stated features, steps, operations, processes, functions, elements, and/or components, but do not preclude the presence or addition of one or more other features, steps, operations, processes, functions, elements, components, and/or groups thereof. As used herein, the term “and/or” includes any and all combinations of one or more of the associated listed items and may be abbreviated as “/”.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

Spatially relative terms, such as “forward”, “rearward”, “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features due to the inverted state. Thus, the term “under” may encompass both an orientation of over and under, depending on the point of reference or orientation. The device may be otherwise oriented (rotated 90 degrees or at other orientations) and the spatially relative descriptors used herein interpreted accordingly. Similarly, the terms “upwardly”, “downwardly”, “vertical”, “horizontal” and the like may be used herein for the purpose of explanation only unless specifically indicated otherwise.

Although the terms “first” and “second” may be used herein to describe various features/elements (including steps or processes), these features/elements should not be limited by these terms as an indication of the order of the features/elements or whether one is primary or more important than the other, unless the context indicates otherwise. These terms may be used to distinguish one feature/element from another feature/element. Thus, a first feature/element discussed could be termed a second feature/element, and similarly, a second feature/element discussed below could be termed a first feature/element without departing from the teachings provided herein.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise.

For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, may represent endpoints or starting points, and ranges for any combination of the data points. For example, if a particular data point “10” and a particular data point “15” may be disclosed, it is understood that greater than, greater than or equal to, less than, less than or equal to, and equal to 10 and 15 may be considered disclosed as well as between 10 and 15. It is also understood that each unit between two particular units may be also disclosed. For example, if 10 and 15 may be disclosed, then 11, 12, 13, and 14 may be also disclosed.

Although various illustrative embodiments have been disclosed, any of a number of changes may be made to various embodiments without departing from the teachings herein. For example, the order in which various described method steps are performed may be changed or reconfigured in different or alternative embodiments, and in other embodiments one or more method steps may be skipped altogether. Optional or desirable features of various device and system embodiments may be included in some embodiments and not in others. Therefore, the foregoing description is provided primarily for the purpose of example and should not be interpreted to limit the scope of the claims and specific embodiments or particular details or features disclosed.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal.

The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

The examples and illustrations included herein show, by way of illustration and not of limitation, specific embodiments in which the disclosed subject matter may be practiced. As mentioned, other embodiments may be utilized and derived therefrom, such that structural and logical substitutions and changes may be made without departing from the scope of this disclosure. Such embodiments of the disclosed subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve an intended, practical or disclosed purpose, whether explicitly stated or implied, may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The disclosed subject matter has been provided here with reference to one or more features or embodiments. Those skilled in the art will recognize and appreciate that, despite of the detailed nature of the example embodiments provided here, changes and modifications may be applied to said embodiments without limiting or departing from the generally intended scope. These and various other adaptations and combinations of the embodiments provided here are within the scope of the disclosed subject matter as defined by the disclosed elements and features and their full set of equivalents.

### COPYRIGHT & TRADEMARK NOTICES

A portion of the disclosure of this patent document may contain material, which is subject to copyright protection. The applicant has no objection to the reproduction of the patent documents or the patent disclosure as it appears in the Patent and Trademark Office patent files or records, but reserves all copyrights whatsoever. Certain marks referenced herein may be common law or registered trademarks of the applicant, the assignee or third parties affiliated or unaffiliated with the applicant or the assignee. Use of these marks is for providing an enabling disclosure by way of example and shall not be construed to exclusively limit the scope of the disclosed subject matter to material associated with such marks.

What is claimed is:

1. A system configured for inferencing performance of a subset of incoming data packets in a population of processed data packets, the system comprising at least one programmable processor to perform operations comprising:
constructing a consortium dataset from training data available from a plurality of data sources, wherein the consortium dataset has a first level of data bias and the training data has a second level of data bias different than the first level of data bias;
utilizing a first predictive model, including an unsupervised learning model, to generate a plurality of homogeneous clusters of data associated with a first population of data packets and a second population of data packets, wherein performance of the first population is known and performance of the second population is unknown, performance of a population indicating possibility of presence of a malicious data packet corresponding to said population;
generating one or more metrics for the plurality of homogeneous clusters of data to evaluate corresponding properties of at least one or more clusters from among the plurality of homogeneous clusters of data;
utilizing a second predictive model, including a supervised learning model, that uses data associated with the first population in the at least one or more clusters to infer the performance of the second population;
generating a set of evaluation reports for the at least one or more clusters, wherein the performance of the second population is validated based on identifiable patterns between the performance of the first population and the performance of the second population;
detecting a malicious data packet in network traffic based on an evaluation of performance of the malicious data packet against at least one of the performance of the first population and the performance of the second population, wherein the network traffic comprises a plurality of data packets; and
eliminating the detected malicious data packet from transmission over the network.

2. The system of claim 1, wherein the set of evaluation reports is generated to confirm that an inferred performance of the second population meets one or more known criteria.

3. The system of claim 1, wherein the second predictive model is trained based on performances of the first population and the inferred performances of the second population.

4. The system of claim 1, wherein the first level of data bias is less than the second level of data bias.

5. The system of claim 1, wherein at least one of the plurality of data sources is associated with a scrutinizing entity, including an entity responsible for approving or denying one or more data packets.

6. The system of claim 1, wherein the first population includes a first set of processed data with packets with known past performances.

7. The system of claim 6, wherein the second population includes a second set of processed data packets with unknown past performances.

8. The system of claim 1, wherein the second predictive model is trained without use of performance tags.

9. The system of claim 1, wherein the second population includes rejected populations or undetermined populations, wherein the rejected populations include denied processed data packets and the undetermined populations include processed data packets that are neither denied nor accepted.

10. The system of claim 1, wherein the first predictive model generates the plurality of homogeneous clusters of data by grouping one or more unlabeled datasets into a predefined number of clusters (K), the clusters associated with corresponding centroids computed in an iterative process until optimal cluster centroids are determined for the respective clusters, random data points being initialized as cluster centroids, a first data point assigned to a closest centroid for a first cluster, wherein new centroids are calculated for the clusters and the random data points are assigned to new centroids forming a new set of clusters as repeated until optimal clusters are formed to minimize within-cluster sum of squares (WCSS) calculated by sum of squared Euclidean distance between a data point and the respective cluster centroid assigned thereto, given by:
$${\sum }_{i = 1}^{k} {\sum }_{j = 1}^{{n}_{i}} {‖ {x}_{j} - {c}_{i} ‖}^{2} ,$$
where k is number of clusters, nᵢ is number of data points in cluster i, cᵢ is a centroid of cluster i, and xⱼ is a data point, and
where ∥xⱼ−cᵢ∥ represents a distance between a data point and a corresponding centroid.

11. An application specific integrated circuit (ASIC) for implementing one or more artificial neural networks (ANNs), the ASIC comprising:
a plurality of neurons organized in an array, wherein a neuron comprises a register, a microprocessor, and at least one input; and
a plurality of synaptic circuits, a synaptic circuit including a memory for storing a synaptic weight, wherein a neuron is connected to at least one other neuron via one of the plurality of synaptic circuits,
wherein performance of an unknown object in a population of objects is inferenced by constructing a consortium dataset from training data in a plurality of data sources, wherein the consortium dataset has a first level of data bias and training data in at least one of the plurality of data sources has a second level of data bias,
wherein the unknown object includes at least one data packet capable of being transmitted over a communications network, the at least one data packet comprising a header portion and a payload portion, the performance of the unknown object indicating whether the at least one data packet is a malicious data packet, and
wherein the at least one data packet is eliminated from being transmitted over the communications network, in response to determining that the performance of the unknown object indicates the at least one data packet is a malicious data packet.

12. The ASIC of claim 11, wherein a first ANN, including an unsupervised learning model, is utilized to create a plurality of homogeneous clusters of data associated with a known populations of objects and an unknown populations of objects.

13. The ASIC of claim 12, wherein one or more metrics is generated for the plurality of homogeneous clusters of data to evaluate corresponding properties of at least one or more clusters from among the plurality of homogeneous clusters of data.

14. The ASIC of claim 13, wherein a second ANN is utilized to infer performance of the unknown populations of objects, the second ANN including a supervised learning model that uses data associated with the known populations of objects in the at least one or more clusters to infer the performance of the unknown populations of objects.

15. The ASIC of claim 14, wherein a set of evaluation reports is generated for the at least one or more clusters.

16. The ASIC of claim 15, wherein the performance of the unknown populations is validated based on identifiable patterns between performances of the known population and performances of the unknown populations.

17. The ASIC of claim 12, wherein the first ANN generates the plurality of homogeneous clusters of data by grouping one or more unlabeled datasets into a predefined number of clusters (K).

18. The ASIC of claim 17, wherein the predefined number of clusters (K) are associated with corresponding centroids computed in an iterative process until optimal cluster centroids are determined for the respective clusters.

19. The ASIC of claim 18, wherein random data points are initialized as cluster centroids, a first data point assigned to a closest centroid for a first cluster, wherein new centroids are calculated for the clusters and the data points are assigned to new centroids forming a new set of clusters as repeated until optimal clusters are formed.

20. The ASIC of claim 19, wherein the optimal clusters are formed to minimize within-cluster sum of squares (WCSS) calculated by sum of squared Euclidean distance between a data point and the respective cluster centroid assigned thereto, given by:
$${\sum }_{i = 1}^{k} {\sum }_{j = 1}^{{n}_{i}} {‖ {x}_{j} - {c}_{i} ‖}^{2} ,$$
where k is number of clusters, nᵢ is number of data points in cluster i, cᵢ is a centroid of cluster i, and xⱼ is a data point, and
where ∥xⱼ−cᵢ∥ represents a distance between a data point and a corresponding centroid.
